(19) United States
(12) Patent Application Publication
(10) Pub. No.: US 2008/0096635 A1
(43) Pub. Date: Apr. 24, 2008

(54) GAMING SYSTEM AND METHOD

(76) Inventor: Kieran Power, Lane Cove (AU)

Correspondence Address: MCANDREWS HELD & MALLOY, LTD, 500 WEST MADISON STREET, SUITE 3400, CHICAGO, IL, 60661, US

(21) Appl. No.: 11/779,161

(22) Filed: Jul. 17, 2007

(30) Foreign Application Priority Data
Oct. 20, 2006 (AU) 2006230744

(51) Int. Cl. G06F 17/00

(52) U.S. Cl. 463/20

(57) ABSTRACT

Certain embodiments of the present invention provide a method of displaying an outcome of a game to a player comprising obtaining a stop position for each of a plurality of reels, each reel having a plurality of symbols, each stop position specifying which symbol or symbols of each reel will correspond to a win line, displaying spinning of each reel to the reel's stop position, determining whether a prize threshold condition is met, and making the display of the spinning of at least one subsequent reel different to the display of at least a first reel if the prize threshold condition is met.

### RELATED APPLICATIONS

This application claims priority to an Australian patent application filed on Oct. 20, 2006, as serial number AU2006230744, entitled “Gaming System and Method.” The foregoing application is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system, a gaming method and a game controller.

Australian patent 603193 discloses a poker machine having a means to cause each reel to turn to a stop in a position where a single line of symbols (one for each reel) is exhibited behind a viewing window. The poker machine has means for determining the length of time for which each reel is spun. If the same symbol is exhibited by a plurality of first stopped reels, normal operation of the machine is suspended and the time for which the next reel is spun is extended. Accordingly, in Australian patent 603193, spinning of a reel is extended in very limited circumstances.

### BRIEF SUMMARY OF THE INVENTION

Certain embodiments of the present invention provide a method of displaying an outcome of a game to a player comprising:
obtaining a stop position for each of a plurality of reels, each reel having a plurality of symbols, each stop position specifying which symbol or symbols of each reel will correspond to a win line;
displaying spinning of each reel to the reel's stop position; and
determining whether a prize threshold condition is met; and
making the display of the spinning of at least one subsequent reel different to the display of at least a first reel if the prize threshold condition is met.

In an embodiment, determining whether a prize threshold is met comprises determining whether a game outcome associated with a prize above a prize threshold will appear possible after a predetermined number of reels have been spun to a stop position.

In an embodiment, determining whether a prize threshold is met comprises determining whether the symbol or symbols on a win line after a predetermined number reels have spun to a stop correspond to a portion of a game outcome associated with a prize above a prize threshold.

In an embodiment, determining whether a prize threshold is met comprises determining whether a prize threshold is met in respect of any one of one or more win lines played by a player.

In an embodiment, determining whether a prize threshold is met comprises determining whether a prize threshold is met based on a combination of two or more win lines played by a player.

In an embodiment, determining a prize threshold based on a number of win lines selected by a player.

In an embodiment, determining a prize threshold based at least partly on a bet amount.

In an embodiment, the prize threshold condition is one of a plurality of suspense conditions and the method comprises determining whether one or more other suspense conditions is met and making display of at least one other reel different if at least one other suspense condition is met.

In an embodiment, making the display different comprises altering at least one of:

the speed of spinning;

the duration of spinning; and

the direction of spinning.

Certain embodiments of the present invention provide a gaming system comprising:
a stop determiner configured to determine a stop position of a each of a plurality of reels, each reel having a plurality of symbols, each stop position specifying which symbol or symbols of the reel will correspond to a win line;
a display for displaying spinning of each reel to the reel's stop position with at least a first reel being spun normally to the first reel's stop position; and
a suspense mode controller configured to determine whether a prize threshold condition is met in relation to one or more win lines and make display of at least one subsequent reel different to at least the first reel if a prize threshold condition is met.

In an embodiment, the suspense mode controller is configured to determine whether a prize threshold is met by determining whether a game outcome associated with a prize above a prize threshold will appear possible after a predetermined number of reels have been spun to a stop position.

In an embodiment, the suspense mode controller is configured to determine whether a prize threshold is met by determining whether the symbol or symbols on a win line after a predetermined number reels have spun to a stop correspond to a portion of a game outcome associated with a prize above a prize threshold.

In an embodiment, the suspense mode controller is configured to determine whether a prize threshold is met in respect of any one of one or more win lines played by a player.

In an embodiment, the suspense mode controller is configured to determine whether a prize threshold is met based on a combination of two or more win lines played by a player.

In an embodiment, the suspense mode controller is configured to determine a prize threshold based on a number of win lines selected by a player.

In an embodiment, the suspense mode controller is configured to determine a prize threshold based at least partly on a bet amount.

In an embodiment, the prize threshold condition is one of a plurality of suspense conditions and the suspense mode controller is configured to determine whether one or more other suspense conditions is met and making display of at least one other reel different if at least one other suspense condition is met.

In an embodiment, the display is made different by altering at least one of:

the speed of spinning;

the duration of spinning; and

the direction of spinning.

Certain embodiments of the present invention provide a suspense mode controller for a gaming system, the suspense mode controller configured to:
obtain a stop determiner configured to determine a stop position of a each of a plurality of reels, each reel having a plurality of symbols, each stop position specifying which symbol or symbols of the reel will correspond to a win line;
determine whether a prize threshold condition is met in relation to one or more win lines; and
make display of at least one subsequent reel different to at least a first reel if a prize threshold condition is met.

In an embodiment, the suspense mode controller is configured to determine whether a prize threshold is met by determining whether a game outcome associated with a prize above a prize threshold will appear possible after a predetermined number of reels have been spun to a stop position.

In an embodiment, the suspense mode controller is configured to determine whether a prize threshold is met by determining whether the symbol or symbols on a win line after a predetermined number reels have spun to a stop correspond to a portion of a game outcome associated with a prize above a prize threshold.

In an embodiment, the suspense mode controller is configured to determine whether a prize threshold is met in respect of any one of one or more win lines played by a player.

In an embodiment, the suspense mode controller is configured to determine whether a prize threshold is met based on a combination of two or more win lines played by a player.

In an embodiment, the suspense mode controller is configured to determine a prize threshold based on a number of win lines selected by a player.

In an embodiment, the suspense mode controller is configured to determine a prize threshold based at least partly on a bet amount.

In an embodiment, the prize threshold condition is one of a plurality of suspense conditions and the suspense mode controller is configured to determine whether one or more other suspense conditions is met and making display of at least one other reel different if at least one other suspense condition is met.

In an embodiment, the display is made different by altering at least one of:

the speed of spinning;

the duration of spinning; and

the direction of spinning.

### BRIEF DESCRIPTION OF SEVERAL VIEWS OF THE DRAWINGS

FIG. 1 is a perspective view of a stand alone gaming machine according to an embodiment;

FIG. 2 is a block diagram of the functional components of a gaming machine according to an embodiment;

FIG. 3 is a schematic diagram of the functional components of a memory according to an embodiment;

FIG. 4 is a schematic diagram of a network gaming system according to an embodiment;

FIG. 5 is an exemplary display during a game in accordance with an example according to an embodiment;

FIG. 6 is a block diagram of the gaming system according to an embodiment; and

FIG. 7 is a flowchart showing the method of an embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Referring to the drawings, there is shown a gaming system arranged to implement a method of displaying a game where display of at least one reel is made different to at least one other reel in response to occurrence of a prize threshold condition in respect of one or more win lines played by a player. The gaming system can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

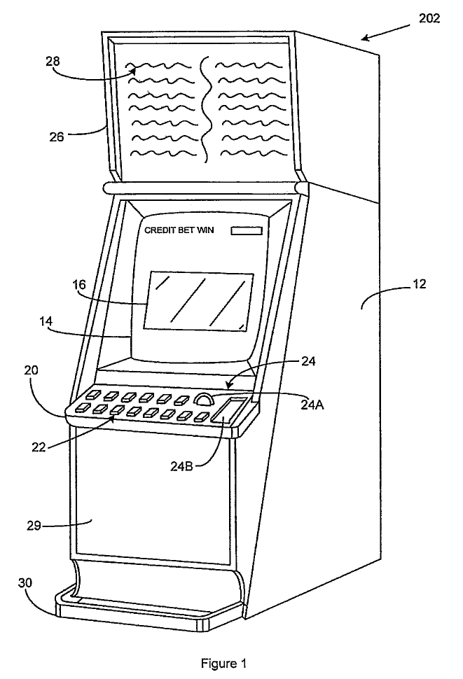

A gaming system in the form of a stand alone gaming machine 10 according to an embodiment is illustrated in FIG. 1. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during gameplay. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

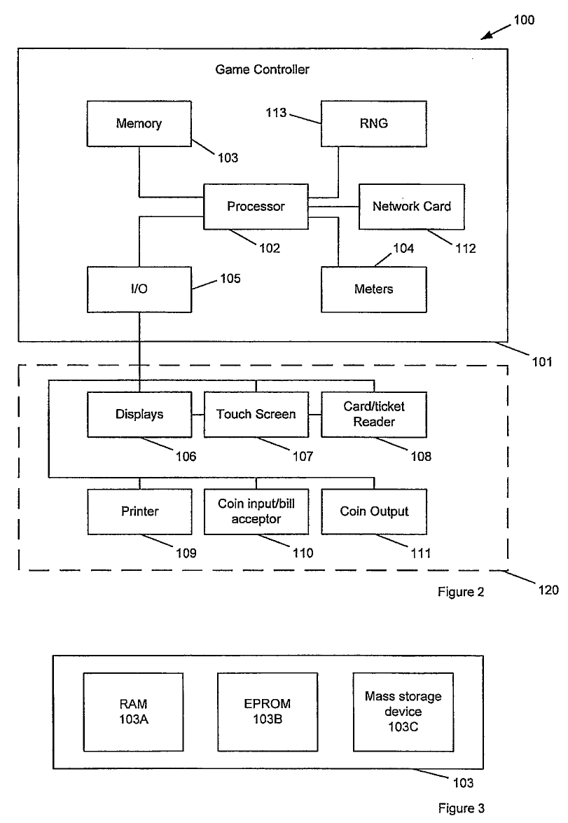

FIG. 2 shows a block diagram of operative components of a typical gaming machine which may be the same as or different to the gaming machine of FIG. 1 according to an embodiment.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 2, a player interface 120 includes peripheral devices that communicate with the game controller 101 comprise one or more displays 106, a touch screen 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 3 shows a block diagram of the main components of an exemplary memory 103 according to an embodiment. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

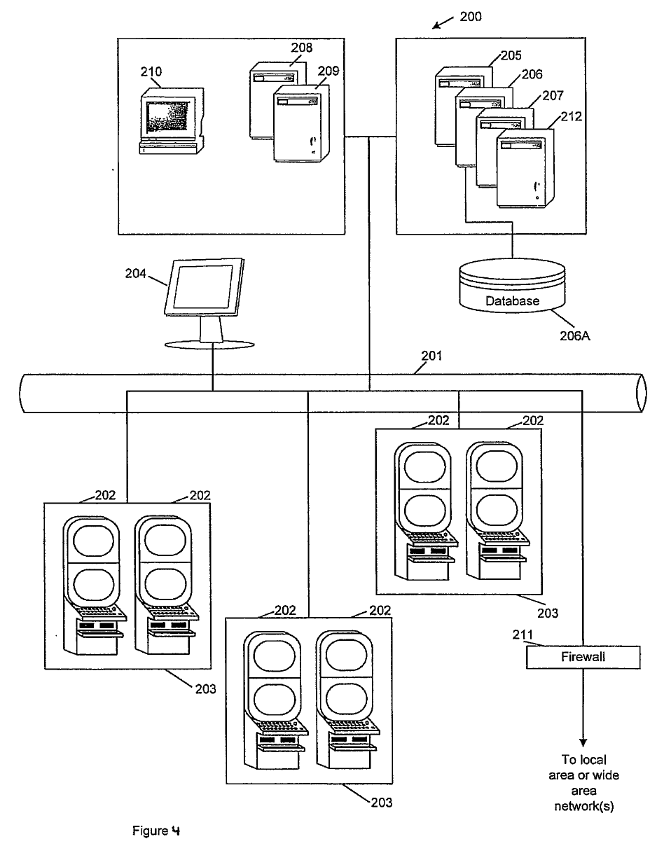

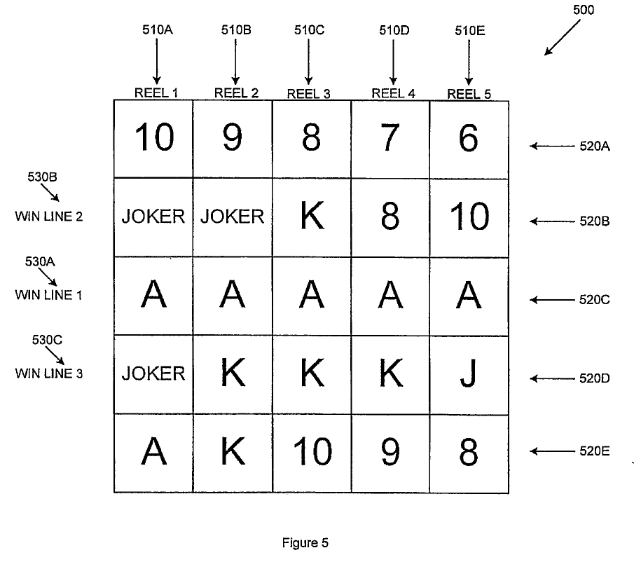

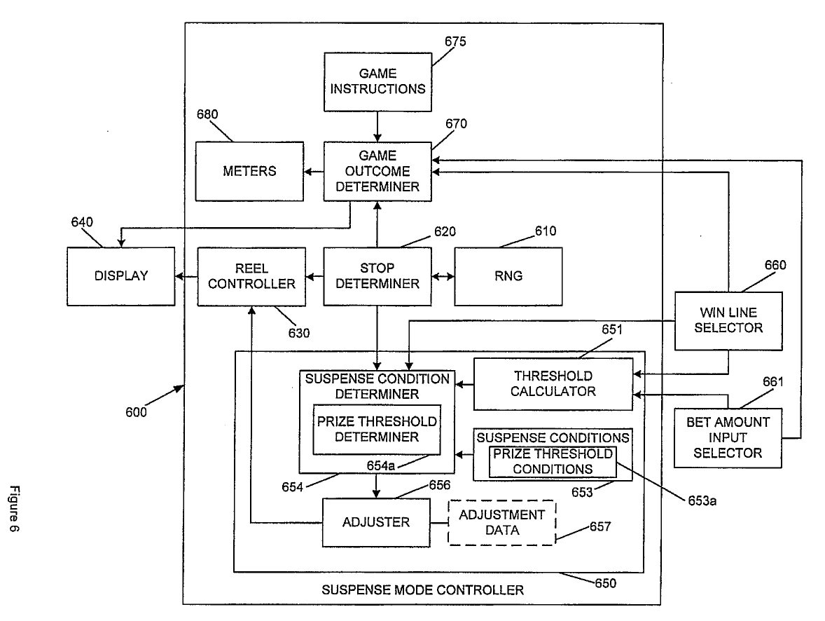

FIG. 4 shows a gaming system 200 in accordance with an embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 1 and 2, or may have simplified functionality depending on the requirements for implementing game play. While banks 203 of two gaming machines are illustrated in FIG. 4, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

In certain embodiments, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, in certain embodiments, a plurality of games servers may be provided to run different games or a single game server may run a plurality of different games as required by the terminals.

Gaming systems for implementing games that involve a display of spinning reels as part of the display of the outcome of a game have either a video display or a mechanical display, these later machines most usually being “stepper” machines which have a separate motor for each reel.

The game controllers of such gaming machines have a stop determining function that determines the stop position for each reel. For example, if there are five reels, each having twenty symbols, the stop determining function might determine that the stop positions are positions: 3, 13, 7, 9 and 17. The spinning of the reels is then controlled so that each symbol comes to a stop in the same row, typically a predetermined row in a “window” visible to the player on the display that which corresponds to a player playing a single win line. When a reel stops, the symbols will be in one of a plurality of possible symbol positions for that reel relative to the stop position.

Embodiments of the present invention relate to gaming systems where a player plays a fixed number of win lines (one or more) and to gaming systems that allow a player to select how many win lines of a plurality of win lines they will play in each game—i.e. a minimum of one win line up to the maximum number of win lines allowed by the game. Each win line is formed by a set of symbol positions consisting of one symbol position from each reel. That is, a predetermined symbol position of each reel is assigned to a win line. The symbol positions that constitute each of the win lines are usually advertised to the player by markings on the display or diagrams showing the symbol positions that correspond to each win line. Some of the win lines will be horizontal or diagonal lines but others may be non-linear combinations of symbols. Typically, the win lines will be constituted by symbol positions in the visible window.

FIG. 6 shows the main functional components of a gaming system 600 of an embodiment. The game controller 605 includes a suspense mode controller 650 that controls whether the gaming system 600 will enter a “suspense mode” where display of the spinning of at least one reel is controlled to be different to the spinning of another reel to thereby enhance game play. The suspense mode controller 650 determines which win lines the player has selected to play and then determines whether a suspense condition is met in relation to the player selected win lines. Depending on the nature of the suspense condition, it may be met in relation to a single win line or by a combination of win lines as described below. Certain embodiments relate specifically to suspense conditions which are prize threshold conditions. In some embodiments the only suspense condition or conditions will be a prize threshold conditions. In other embodiments, a prize threshold condition may be one of a number of suspense conditions.

In order to play the game, the player enters credits using a credit mechanism in a conventional manner. The player then operates the player interface to specify the amount they want to bet per win line and the number of win lines they wish to play by operating a win line selector 660. That is, the player may play one or a plurality of win lines up to the maximum number of win lines available for the game. For example if there are a maximum of three win lines, the player may play one, two or three win lines. A stop determiner 620, obtains random numbers from the random number generator 610 and uses them to determine the stop position of each of the reels. As described above, the stop positions will specify which symbols of each reel will correspond to win lines.

The stop positions are supplied by the stop determiner 620 to a reel controller 630 which controls the display of the spinning of individual reels to stop positions on display 640. In normal operation of a video display this will result in a display where the reel is animated so that initially the reel is imperceptible to give the impression of spinning and then the symbols become perceptible so that a certain number of symbols (for example 6 symbols) can be viewed by the player before the reel reaches the stop position. In a mechanical display, the reel needs to be moved from its current stop position (from the previous game) to the new stop position. The duration and speed of spinning will be either the same for each reel or within normal ranges.

As described in further detail below the reel controller 630 may also receive an adjustment instruction from suspense mode controller 650 which is used by the reel controller 630 to control the display of spinning of the reels to make display of at least one reel different. The stops are also provided to a game outcome processor 670. The game outcome processor 670 processes the stop positions in accordance with the game rules 675 and the selected win lines to determine whether the player has won. The game outcome processor 670 alters meters 680 based on the game outcome and causes the prize outcome to be displayed on the display 640 once the reel controller 630 has caused the display 640 to display all reels spinning to a stop position.

The suspense mode controller 650 determines whether one or more adjustment instructions are to be supplied to the reel controller 630 during a game. The adjustment instruction causes the reel controller 630 to alter the display of spinning of at least one reel.

The suspense condition determiner 654 processes the win lines that are selected by win line selector 660 in conjunction with the reel stop positions produced by the stop determiner 620 to determine the symbols that will appear on win lines that a player has selected.

This allows the suspense condition determiner 654 to determine whether a suspense condition will be satisfied. If a suspense condition is satisfied, adjuster 656 determines an adjustment and supplies it to the reel controller 630. If in a specific embodiment only one type of adjustment is applied, the adjuster sends an adjustment instruction to the reel controller 630 which is configured to make the relevant adjustment. Depending on the embodiment the adjuster 656 may calculate the adjustment based on a predetermined formula or obtain the relevant adjustment from adjustment data 657 and send it as an adjustment instruction specifying the adjustment to reel controller 630 for implementation.

In certain embodiments, the suspense condition determiner 654 includes a prize threshold determiner 654a.

The prize threshold determiner 654a determines what game outcomes in a pay table will appear sufficiently likely after a certain number of reels have spun to a stop. Based on the associated prizes of those game outcomes, the prize threshold determiner 654a determines whether any of the prizes are above the prize threshold. In order to determine whether an outcome appears sufficiently possible, one approach is to evaluate a subset of all game outcomes. Different game outcomes may be evaluated after a certain number of reels. For example, some may be evaluated after two reels and others only after three reels.

A sub routine for each game outcome can determine whether after the relevant reel, symbols will appear on a winline corresponding to the game outcome monitored by the sub routine. If the intention is to monitor for game outcomes above a threshold in respect of any one win line, only those outcomes having a prize above the threshold need be monitored.

Alternatively, it may be required that the total of the win outcomes that appear possible across all win lines played by the player exceed a prize threshold such that possible outcomes from separate win lines can contribute to that total. That is, in this embodiment apparent game outcomes with prizes below the threshold on an individual win line will not trigger a suspense mode but if the total of prizes that appear possible after a certain number of reels exceeds the threshold the suspense mode may be entered into. Different thresholds may be set for different numbers of reels having spun to a stop and/or different numbers of win lines. Again, not all potential winning outcomes need be monitored. That is, it may only be necessary to monitor for outcomes that can made a significant contribution to passing the threshold.

Optionally the suspense mode controller includes a threshold calculator 651 for determining a threshold to be applied based on the number of selected win lines obtained from win line selector 660 and/or the amount bet obtained from the bet amount selector 61. Whether the prize threshold is calculated or predetermined it is used as the basis of the prize threshold determiner's 654a determination.

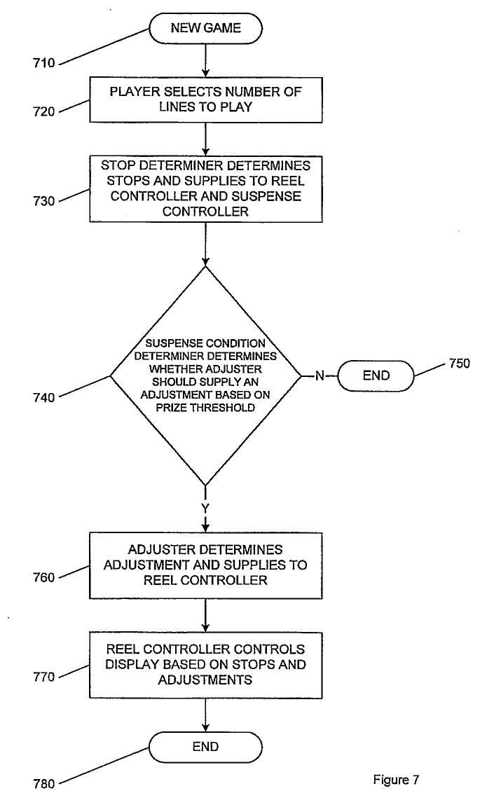

Referring to the flow chart in FIG. 7 of an embodiment, at step 710 a new game is started. At step 720 a player operates the win line selector to select a number of lines to play. At step 730 the stop determiner determines the stops and supplies data specifying these to the reel controller and the suspense condition determiner. At step 740 the suspense conditioner determiner determines whether the adjuster should generate adjustment data based on the prize threshold possible outcomes. If a prize threshold condition is not met, the process stops 750 for this game. If a prize threshold condition is met, at step 760 the adjuster determines an adjustment and supplies it to the reel controller as adjustment data. At step 770 the reel controller controls displays of spinning of each reel to the stop position based on the stops and adjustments. At step 780 the game ends.

The above process can be combined with determining whether any other suspense condition is met.

Other Suspense Conditions

Other suspense conditions may be based on a predetermined game outcome still being possible after one or more reels are spun to a stop position. The game outcome may be an entry in a pay table for the game or may be a value derived from the pay table such as a prize threshold. The number of reels that are required to have reached the stop position may form part of the suspense condition. For example, one suspense condition may be invoked in relation to a “wild” symbol that can be substituted for any other symbol. In this case even after a first reel is spun to a stop position, if a wild symbol corresponds to a win line, at that point in the game, it will appear to the player that they have a higher likelihood of winning a prize and accordingly it may be appropriate to determine that a suspense condition has been met. In contrast, if a prize is awarded for five symbols of the same type, it may be appropriate to trigger a suspense condition after two or three symbols of the same type have been spun to a stop on the same win line.

A suspense condition may be based on a combination of two or more factors, for example the size of the prize corresponding to the outcome that appears possible and how likely it appears after a reel has spun to a stop that the player will win the prize; that is, based on the probability of the outcome occurring.

By way of specific example, in one game a prize may be awarded for five aces and may be the maximum prize for that game. A lesser prize may be awarded for four aces. A suspense condition may be set in relation to the five ace prize, so that if the first three reels each have aces on a win line, a suspense mode may be triggered. That is, the five ace prize appears to be possible after three reels and is judged to be sufficiently likely once the first three reels have aces. If the first three reels are two aces and a king, suspense mode is not entered into and suspense mode will only be entered into if three of the first four reels are aces because it is not until the fourth reel that it is deemed that it will appear sufficiently likely that they will win the four ace prize and hence it is deemed appropriate to enter the suspense mode in view of the size of the prize. In this example, for a higher prize a relatively lower likelihood is sufficient to trigger a suspense mode.

The above suspense conditions relate to a symbol combination on a single win line, however the suspense condition may based on multiple win lines. For example, in one embodiment a suspense mode may only be entered into if a game outcome from the pay table appears possible in relation to two or more win lines played by a player. That is, a subset of all winning outcomes specified in the pay table may be sufficient to initiate a suspense mode if two or more such winning outcomes appear possible for different win lines.

Adjustments

The display may be adjusted by altering the duration of the spinning of one or more reels. For example, if two aces appear on the first reel and second reels, the duration of spinning of the third reel may be extended.

Alternatively, the speed of spinning or a reel may be adjusted. For example, if aces appear on the first four reels, the duration of the spinning of the fifth reel may be the same but the speed of the spinning of the fifth reel may be slowed so that the player can more readily perceive the symbols on the reel as they move into position or sped up as an indicator of excitement.

Another possible adjustment of the display is to reverse the direction of spinning of the reel.

It is possible to combine variations of spinning. For example, in an example where a winning outcome appears possible on multiple reels, if a winning outcome appears possible on one reel, the duration may be altered but if it appears possible on two win lines, both duration and speed may be altered.

In certain embodiments, multiple duration and multiple speed variations may be possible. The adjuster 656 may determine a size of an adjustment dependent on:
a) the size of the prize;
b) the number of reels in relation to which a suspense condition is met;
c) a number of suspense conditions that are met; or
d) the likelihood of a prize outcome.

For example, in a case where five aces appear on a reel, the duration of the spin may be extended for a first time after two aces appear, a second time after three aces appear and a third time once four aces appear and it appears highly likely the player will win the prize corresponding to five aces.

A suspense mode will be ended if a suspense condition is no longer met and there are more reels to be spun.

### EXAMPLE

Referring to FIG. 5 there is shown an exemplary display 500 that may occur during a game. In the gaming machine of FIG. 5 five lines of symbols 520A to 520E are displayed on the display once all reels have spun to a stop. There are five reels 510A to 510E. While five lines are displayed, only three lines 530A, 530B and 530C are win lines. If the player selects to play one win line, they play win line one 530A. Win line two 530B is also played if they select two win lines and win line three is added 530C if they select three win lines.

The player chooses to play three win lines. A prize of $800 is awarded for five Kings (K) and a prize of $600 is awarded for five Aces (A). The prize threshold condition is that after three or four reels there are game outcomes on multiple reels that sum to more than the prize threshold. The prize threshold is $500 multiplied by the number of win lines the player is playing; $1,500 for three win lines. Reels one to five 510A to 510E are spun to a stop in numerical order (left to right). Referring to FIG. 5, after reel three spins to a stop position it appears possible for the player to obtain five aces on win line one and five kings on both win lines two and three. Therefore, a total prize of $2,000 appears possible which is greater then $1,500 and hence the threshold condition is met and suspense mode is initiated. When reel four spins to a stop, one of the five king results is no longer possible and the total possible prize is $1,400, less than the threshold. Thus, the threshold condition is no longer met and suspense mode is ended.

Various modifications will be apparent to persons skilled in the art, and should be understood as falling within the scope of the appended claims.

For the purposes of this specification it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Australia or any other country.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of displaying an outcome of a game to a player comprising:
obtaining a stop position for each of a plurality of reels, each reel having a plurality of symbols, each stop position specifying which symbol or symbols of each reel will correspond to a win line;
displaying spinning of each reel to the reel's stop position;
determining whether a prize threshold condition is met; and
making the display of the spinning of at least one subsequent reel different to the display of at least a first reel if the prize threshold condition is met.

2. A method as claimed in claim 1, wherein determining whether a prize threshold is met comprises determining whether a game outcome associated with a prize above a prize threshold will appear possible after a predetermined number of reels have been spun to a stop position.

3. A method as claimed in claim 1, wherein determining whether a prize threshold is met comprises determining whether the symbol or symbols on a win line after a predetermined number reels have spun to a stop correspond to a portion of a game outcome associated with a prize above a prize threshold.

4. A method as claimed in claim 1, wherein determining whether a prize threshold is met comprises determining whether a prize threshold is met in respect of any one of one or more win lines played by a player.

5. A method as claimed in claim 1, wherein determining whether a prize threshold is met comprises determining whether a prize threshold is met based on a combination of two or more win lines played by a player.

6. A method as claimed in claim 5, comprising determining a prize threshold based on a number of win lines selected by a player.

7. A method as claimed in claim 1, comprising determining a prize threshold based at least partly on a bet amount.

8. A method as claimed in claim 1, wherein the prize threshold condition is one of a plurality of suspense conditions and the method comprises determining whether one or more other suspense conditions is met and making display of at least one other reel different if at least one other suspense condition is met.

9. A method as claimed in claim 1, comprising making the display different by altering at least one of:
the speed of spinning;
the duration of spinning; and
the direction of spinning.

10. A gaming system comprising:
a stop determiner configured to determine a stop position of a each of a plurality of reels, each reel having a plurality of symbols, each stop position specifying which symbol or symbols of the reel will correspond to a win line;
a display for displaying spinning of each reel to the reel's stop position with at least a first reel being spun normally to the first reel's stop position; and
a suspense mode controller configured to determine whether a prize threshold condition is met in relation to one or more win lines and make display of at least one subsequent reel different to at least the first reel if a prize threshold condition is met.

11. A gaming system as claimed in claim 10, wherein the suspense mode controller is configured to determine whether a prize threshold is met by determining whether a game outcome associated with a prize above a prize threshold will appear possible after a predetermined number of reels have been spun to a stop position.

12. A gaming system as claimed in claim 10, wherein the suspense mode controller is configured to determine whether a prize threshold is met by determining whether the symbol or symbols on a win line after a predetermined number reels have spun to a stop correspond to a portion of a game outcome associated with a prize above a prize threshold.

13. A gaming system as claimed in claim 10, wherein the suspense mode controller is configured to determine whether a prize threshold is met in respect of any one of one or more win lines played by a player.

14. A gaming system as claimed in claim 10, wherein the suspense mode controller is configured to determine whether a prize threshold is met based on a combination of two or more win lines played by a player.

15. A gaming system as claimed in claim 14, wherein the suspense mode controller is configured to determine a prize threshold based on a number of win lines selected by a player.

16. A method as claimed in claim 10, wherein the suspense mode controller is configured to determine a prize threshold based at least partly on a bet amount.

17. A gaming system as claimed in claim 10, wherein the prize threshold condition is one of a plurality of suspense conditions and the suspense mode controller is configured to determine whether one or more other suspense conditions is met and making display of at least one other reel different if at least one other suspense condition is met.

18. A gaming system as claimed in claim 10, wherein the display is made different by altering at least one of:
the speed of spinning;
the duration of spinning; and
the direction of spinning.

19. A suspense mode controller for a gaming system, the suspense mode controller configured to:
obtain a stop determiner configured to determine a stop position of a each of a plurality of reels, each reel having a plurality of symbols, each stop position specifying which symbol or symbols of the reel will correspond to a win line;
determine whether a prize threshold condition is met in relation to one or more win lines; and
make display of at least one subsequent reel different to at least a first reel if a prize threshold condition is met.

20. A suspense mode controller as claimed in claim 19, wherein the suspense mode controller is configured to determine whether a prize threshold is met by determining whether a game outcome associated with a prize above a prize threshold will appear possible after a predetermined number of reels have been spun to a stop position.

21. A suspense mode controller as claimed in claim 19, wherein the suspense mode controller is configured to determine whether a prize threshold is met by determining whether the symbol or symbols on a win line after a predetermined number reels have spun to a stop correspond to a portion of a game outcome associated with a prize above a prize threshold.

22. A suspense mode controller as claimed in claim 19, wherein the suspense mode controller is configured to determine whether a prize threshold is met in respect of any one of one or more win lines played by a player.

23. A suspense mode controller as claimed in claim 19, wherein the suspense mode controller is configured to determine whether a prize threshold is met based on a combination of two or more win lines played by a player.

24. A suspense mode controller as claimed in claim 23, wherein the suspense mode controller is configured to determine a prize threshold based on a number of win lines selected by a player.

25. A method as claimed in claim 19, wherein the suspense mode controller is configured to determine a prize threshold based at least partly on a bet amount.

26. A suspense mode controller as claimed in claim 19, wherein the prize threshold condition is one of a plurality of suspense conditions and the suspense mode controller is configured to determine whether one or more other suspense conditions is met and making display of at least one other reel different if at least one other suspense condition is met.

27. A suspense mode controller as claimed in claim 19, wherein the display is made different by altering at least one of:
the speed of spinning;
the duration of spinning; and
the direction of spinning.
